(19) United States
(12) Patent Application Publication
(10) Pub. No.: US 2014/0337204 A1
(43) Pub. Date: Nov. 13, 2014

(54) System and Method of Calculating the Pricing of Credit Based on Engagement with a Wellness Programme

(71) Applicant: Discovery Limited, Sandton (ZA)

(72) Inventors: Adam Ian Noach, Sandton (ZA); Darren Segal, Johannesburg (ZA); Robert Hutchinson-Keip, Johannesburg (ZA)

(21) Appl. No.: 14/364,004

(22) PCT Filed: Nov. 28, 2012
(86) PCT No.: PCT/IB12/56780

§ 371 Date: Jun. 9, 2014

(30) Foreign Application Priority Data
Dec. 9, 2011 (ZA) 2011/09078

(51) Int. Cl. G06Q 40/02

(52) U.S. Cl. CPC G06Q 40/025
USPC 705/38

(57) ABSTRACT

A system and method of calculating the pricing of credit based on engagement with a wellness programme includes monitoring the compliance of a person with a wellness programme and storing data relating to the compliance of the person with a wellness programme. The stored wellness data is used as one factor to calculate the pricing of credit wherein the higher the degree of compliance with the wellness programme the cheaper the pricing of the credit.

### BACKGROUND OF THE INVENTION

The present application relates to a system and method of calculating the pricing of credit based on engagement with a wellness programme.

There is currently no use of the level of engagement in a wellness programme as a tool to price credit.

However, research conducted by the applicant on their own wellness and credit card products has found a correlation between people that look after their wellness and people that look after their credit.

The present invention therefore provides a system and method of calculating the pricing of credit based on engagement with a wellness programme.

### SUMMARY OF THE INVENTION

According to one example embodiment, a method of calculating the pricing of credit based on engagement with a wellness programme, the method including:
monitoring the compliance of a person with a wellness programme;
storing data relating to the compliance of the person with a wellness programme; and
using the stored wellness data as one factor to calculate the pricing of credit wherein the higher the degree of compliance with the wellness programme the cheaper the pricing of the credit.

In one example, the monitoring of the compliance of the person with the wellness programme may include receiving person participation information associated with the person's participation in the wellness program.

The method may also include determining, based on the participation information, a status level associated with the person for the wellness program, wherein the status level indicates a degree of participation in the wellness program and wherein the calculating of the pricing of credit uses the status level.

The participation information received may include information associated with a plurality of separate and distinct occurrences of wellness program participation by the person.

According to another example embodiment, a system of calculating the pricing of credit based on engagement with a wellness programme, the system including:
a monitoring module to monitor the compliance of the person with a wellness programme;
a database for storing data relating to the compliance of the person with a wellness programme; and
a calculation module to using the stored wellness data as one factor to calculate the pricing of credit wherein the higher the degree of compliance with the wellness programme the cheaper the pricing of the credit.

The monitoring module may monitor the compliance of the person with the wellness programme by receiving person usage information associated with the person's usage of the wellness programme.

The usage information received typically includes information associated with a plurality of separate and distinct occurrences of wellness programme participation by the person.

In one example, the monitoring module determines, based on the activity information, a points value or a status level associated with the person for the wellness programme, wherein the points value or the status level indicates a degree of participation in the wellness programme and wherein the calculation module uses the points value or status level as one factor to calculate the pricing of credit wherein the higher the degree of compliance with the wellness programme the cheaper the pricing of the credit.

In one example, the monitoring module monitors the compliance of the person with the wellness programme by:
receiving person participation information associated with the person's participation in the wellness program; and
determining, based on the participation information, a status level associated with the person for the wellness program, wherein the status level indicates a degree of participation in the wellness program.

In this example, the calculation module uses the status level as one factor to calculate the pricing of credit.

### BRIEF DESCRIPTION OF THE DRAWINGS

FIG. 1 is a block diagram illustrating an example system to implement the methodologies described herein;

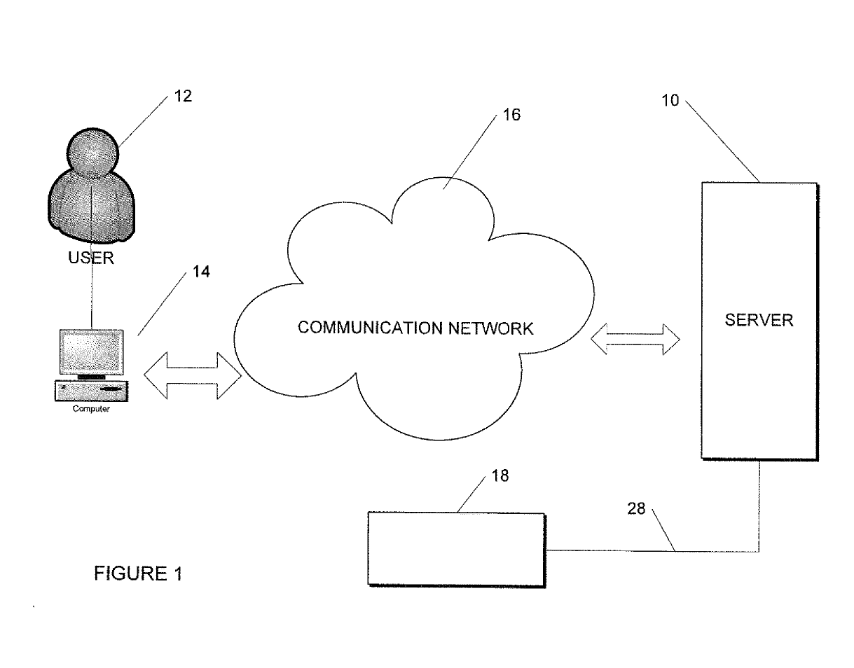

FIG. 2 is a block diagram illustrating an example server in more detail; and

FIG. 3 is a flow chart illustrating the methodology of an example embodiment.

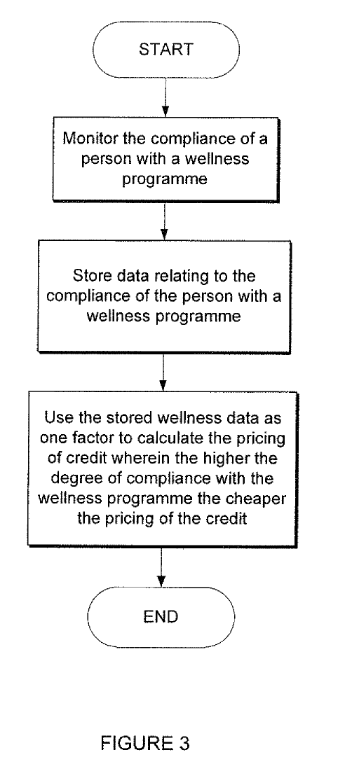

### DESCRIPTION OF EMBODIMENTS

The systems and methodology described herein relate to a system and method of calculating the pricing of credit based on engagement with a wellness programme.

Referring to the accompanying figures, the compliance of the person with a wellness programme is monitored.

An example of such a wellness program is presently managed by the applicant that manages a traditional life and health insurance plan together with their wellness program disclosed in the applicant's South African granted patent number ZA 99/1746, the contents of which are incorporated herein by reference.

In an example wellness program, members participate in approved related facilities and/or services. For example, members use gymnasiums, Smoke Enders™ and Weighless™.

Thus examples of compliance with a wellness program might include:
Compliance with a fitness programme;
Weight loss programme compliance;
Smoking cessation;
The purchase of healthy food products; and
The compliance with drug regimes.

In one example, members 12 are awarded points and depending on the total number of points allocated to a member, they fall within one of five statuses. In the implementation of the wellness program, these statuses have been named in ascending order of value, blue, bronze, silver, gold and diamond. All members 12 are placed initially in the blue status. Once a member has accumulated a predetermined number of points, his/her status is upgraded to the next appropriate level.

It will be appreciated that for purposes of the present invention the wellness programme could be operated by the credit provider or could be operated by a third party that operates the wellness programme and then informs the credit provider of the degree of participation of the person with the wellness programme.

This could occur by a third party 18 transmitting data to at least one server 10 operated by the credit provider. The data is received at the server 10 and stored in a database 20 associated with the at least one server.

In one example the data will include at least an identity of the member and data identifying the status of the member, for example blue, bronze, silver, gold and diamond.

In order to determine the status, a monitoring of the compliance of the member with the wellness programme includes receiving member usage information associated with the member's usage of the wellness program and determining, based on the usage information, a status level associated with the member for the wellness program, wherein the status level indicates a degree of participation in the wellness program

The usage information received may include information associated with a plurality of separate and distinct occurrences of wellness program participation by the member.

The usage information can then be used to price credit as will be described below.

In an alternative embodiment, the method may further include determining a status level associated with the member that further includes receiving the usage information from an information processing system and assigning a given point value to each separate and distinct occurrence of wellness program participation.

A total point value is determined based on an accumulation of each given point value assigned to each separate and distinct occurrence of wellness program participation

The total point value is then compared to a plurality of point ranges, each point range in the plurality of point ranges being associated with a status level and identifying a point range in the plurality of point ranges corresponding to the total point value.

Finally, a status level is assigned that is associated with the point range that has been identified to the member.

Data relating to the compliance of the person with the wellness programme is stored in the database 20.

In one example embodiment, the stored wellness data is used by a calculation module 22 as one factor to calculate the pricing of credit wherein the higher the degree of compliance with the wellness programme the cheaper the pricing of the credit.

One example of doing this is as follows, if the probability of default can be assigned by status, then for example:

| | | |
|---|---|---|
| Blue | 5% | (use as the base case) |
| Bronze | 4% | |
| Silver | 3.5% | |
| Gold | 2% | |
| Diamond | 1.5% | |

In this example it should be possible to give bronze members a lower interest rate than blue members and silver members would qualify for an even better interest rate and so on.

It will be appreciated that the lower interest rates need not be as explicitly linked to wellness status as described above. The wellness status could be used as one of the indicators used in a credit scorecard. This would increase the accuracy of the scorecard introducing a new measure which is linked to a wellness profile.

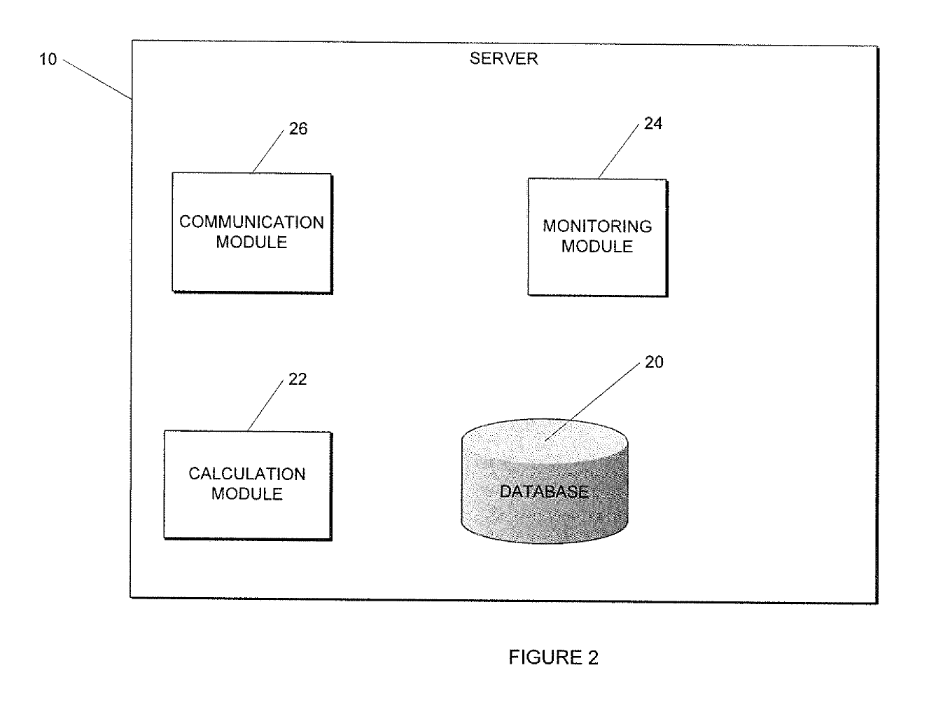

FIG. 2 illustrates an exemplary system for implementing the above methodologies.

A server 10 includes a number of modules to implement the methodologies described above.

A monitoring module 24 is specifically constructed to define a wellness programme and monitor the compliance of the wellness programme by the member.

The monitoring of the compliance of the member with the wellness programme includes receiving by the communication module 26, member usage information associated with the member's usage of the wellness programme.

The usage information received may include information associated with a plurality of separate and distinct occurrences of wellness programme participation by the member.

The monitoring module 24 determines, based on the usage information, a points value or a status level associated with the member for the wellness programme, wherein the points value or the status level indicates a degree of participation in the wellness programme

In addition, the monitoring module 24 may further be constructed to determine a status level associated with the member by receiving the usage information from an information processing system and assigning a given point value to each separate and distinct occurrence of wellness programme participation.

A total point value is determined by the monitoring module 24 based on an accumulation of each given point value assigned to each separate and distinct occurrence of wellness programme participation

The total point value is then compared to a plurality of point ranges by the monitoring module 24 each point range in the plurality of point ranges being associated with a status level and identifying a point range in the plurality of point ranges corresponding to the total point value.

Finally, a status level is assigned by the monitoring module 24 that is associated with the point range that has been identified to the at least one employee.

The monitoring module 24 then writes the total points value or the status level to a memory, for example the database 20.

In either case the calculation module 22 accesses the memory and retrieves the stored total points value or status level.

The calculation module 22 is constructed to calculate the pricing of the credit as has been explained,

As mentioned above, the system includes at least one associated database 20 for storing data to be used by one or more of the above referenced modules.

In addition, the server is typically connected to a communications network for communications with other computers to implement the methodologies described above.

The server 10 may also be connected to another communications network in the form of the Internet 16 so that members 12 are able to access the server and obtain information either about their wellness status or the pricing of their credit.

In addition, member's may be allowed, via this communications network to access questionnaires over the Internet 16 using a computer 14 whereby their answers to these questions could be used as part of the wellness programme compliance assessment.

The modules described above may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

In another example embodiment the modules may be implemented using firmware programmed specifically to execute the method described herein.

It will also be appreciated that in any of these cases the modules form a physical apparatus with physical modules specifically for executing the steps of the method described herein.

In other embodiments, the member may be rewarded in ways other than lower interest rates. One way would be to discount the fees and bank charges that the customer pays for banking transactions. The discounts would be tiered in relation to the wellness status.

A similar reward could accrue to customers who are not borrowers whereby credit interest paid on savings and investment accounts could be tiered by the wellness status.

Finally, rewards for reduced credit risk as measured by the wellness status, could be paid out to customers in the form of rewards including but not limited to discounts on retail partners (e.g. discounted airline tickets, discounts at retail partner stores, discounts on own products).

1. A method of calculating the pricing of credit based on engagement with a wellness programme, the method including:
monitoring, with a computer, the compliance of a person with a wellness programme;
storing, with a computer, data relating to the compliance of the person with a wellness programme; and
using the stored wellness data as one factor to calculate, with a computer, the pricing of credit wherein the higher the degree of compliance with the wellness programme the cheaper the pricing of the credit.

2. A method according to claim 1 wherein the monitoring of the compliance of the person with the wellness programme includes receiving, with a computer, participation information data associated with the person's participation in the wellness program.

3. A method according to claim 2 wherein the method also includes determining, with a computer, based on the participation information data, a status level associated with the person for the wellness program, wherein the status level indicates a degree of participation in the wellness program and wherein the calculating of the pricing of credit uses the status level.

4. A method according to claim 2 wherein the participation information data received includes information associated with a plurality of separate and distinct occurrences of wellness program participation by the person.

5. A method according to claim 1 wherein the higher the degree of compliance with the wellness programme the lower the interest rate charged for the credit.

6. A computer system for calculating the pricing of credit based on engagement with a wellness programme, the system including:
a monitoring module to monitor the compliance of a person with a wellness programme;
a database for storing data relating to the compliance of the person with a wellness programme; and
a calculation module to use the stored wellness data as one factor to calculate the pricing of credit wherein the higher the degree of compliance with the wellness programme the cheaper the pricing of the credit.

7. A computer system according to claim 6 wherein the monitoring module monitors the compliance of the person with the wellness programme by receiving usage information associated with the person's usage of the wellness programme.

8. A computer system according to claim 7 wherein the usage information received includes information associated with a plurality of separate and distinct occurrences of wellness programme participation by the person.

9. A computer system according to claim 7 wherein the monitoring module determines, based on the activity information, a points value or a status level associated with the person for the wellness programme, wherein the points value or the status level indicates a degree of participation in the wellness programme and wherein the calculation module uses the points value or status level as one factor to calculate the pricing of credit wherein the higher the degree of compliance with the wellness programme the cheaper the pricing of the credit.

10. A computer system according to claim 6 wherein the monitoring module monitors the compliance of the person with the wellness programme by:
receiving participation information associated with the person's participation in the wellness program; and
determining, based on the participation information, a status level associated with the person for the wellness program, wherein the status level indicates a degree of participation in the wellness program.

11. A computer system according to claim 10 wherein the calculation module uses the status level as one factor to calculate the pricing of credit.
